(19) United States
(12) Patent Application Publication
(10) Pub. No.: US 2025/0390354 A1
(43) Pub. Date: Dec. 25, 2025

(54) OPTIMIZED EXECUTION OF SERVICES VIA SERVICE REQUEST BUNDLING

(71) Applicant: SEP SE, Walldorf (DE)

(72) Inventors: Karolin Laicher, Bruchsal (DE); Tobias Julius Neubert, Muehlhausen (DE); Vijaya Geetha Samireddypalle, Bangalore (IN); Himanshu Gugnani, Dielheim (DE); Heiko Braumann, Dresden (DE); Olga George, Dresden (DE); Alexander Dobl, Dresden (DE); Stefan Heydenreich, Kaebschuetztal (DE); Michael Bender, Reilingen (DE); Benjamin Reim, Dresden (DE); Jingjing Guo, Walldorf (DE); Vineesh Varghese, Duesseldorf (DE); Vikas Upadhyay, Leimen (DE); Suyash Goyal, Bangalore (IN); Himani Bhandari, Bangalore (IN); Jixon Jolly Kannokkadan, Bangalore (IN); Sreekanth Reddy G, Bangalore (IN); Sravani Anantha, Bangalore (IN); Sugandha Verma, Bangalore (IN); Pooja Kumari, Bangalore (IN); Venkata Narayana Reddy Muchukota, Bangalore (IN); Suha Khan, Bangalore (IN); Deep Gaurav, Bangalore (IN); Rajarajan Anbalagan, Bangalore (IN); Akshita Akshita, Bangalore (IN); Swati Agarwal, Bangalore (IN); Chinmay Singh, Bangalore (IN); Pooja Singh, Bangalore (IN); Suman Panja, Bangalore (IN); Tanmeya Mohan, Bangalore (IN)

(21) Appl. No.: 18/748,852

(22) Filed: Jun. 20, 2024

(51) Int. Cl. G06F 9/50

(52) U.S. Cl. CPC G06F 9/5038

(57) ABSTRACT

In an example embodiment, multiple service requests are bundled into a single bundle via the vertical bundling of the service requests. This involves modularizing the services into subcomponents, identifying common processes and identifying the modularized processes that can run in parallel, then ranking the modularized processes to create an execution plan that minimizes downtime and also schedules downtime in a single contiguous block. The execution plan represents an optimized executable sequence that can contain both related and non-related services in a single bundle for fulfillment. It also represents a blueprint of services requested by the user from a service catalog.

### TECHNICAL FIELD

This document generally relates to computer software request processing. More specifically, this document relates to the optimized execution of services via service request bundling.

### BACKGROUND

Cloud software applications (or “applications”) can generally use services exposed by the environment they are running in. The services range from low-level services such as a file system to high-level domain specific business services. Some processes performed by some of the exposed services may involve varying levels of downtime in various systems. For example, a service request to update database software generally involves taking the database offline for some period of time. Minimization of such downtime is desirable.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a system for executing a plurality of service requests, in accordance with an example embodiment.

FIG. 2 is a diagram illustrating an example of modules of two services offered by a service provider, in accordance with an example embodiment.

FIG. 3 is a diagram illustrating a ranking of modules of a service provider, in accordance with an example embodiment.

FIG. 4 is a diagram illustrating an execution plan formed via the ranking 300 and a service request that requests execution of the first and second services, in accordance with an example embodiment.

FIG. 5 is a flow diagram illustrating a method for executing a service request containing multiple services, in accordance with an example embodiment.

FIG. 6 is a block diagram illustrating an architecture of software, which can be installed on any one or more of the devices described above.

FIG. 7 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

In an example embodiment, a unified interface may be provided to allow users to request multiple services across multiple systems/tenants at the same time. This is known as a horizontal service request. The user indicates, within the unified interface, a plurality of different services to execute, and the unified interface is able to schedule and execute these different services.

When dealing with multiple service requests that require downtime of the same device or application, a technical issue is encountered with respect to the scheduling of the multiple services requests. Specifically these requests are scheduled sequentially, which not only increases the amount of collective downtime for devices or applications but also creates a scenario where multiple disruptive cycles of uptime and downtime are scheduled.

For example, take a scenario where a first service of applying a security patch to one portion of a database and a second service of updating database software as a whole are requested. The first service needs about 4 hours of preparation time, 3 hours of execution time (during which the database must be down), and 30 minutes of post-processing time. The second service needs about 24 hours of preparation time, 5 hours of execution time (during which the database must be down), and 1 hour of post-processing time. Scheduling the two services sequentially requires 1 day, 13 hours, and 30 minutes of execution time overall of which about 8 hours will be downtime. The user will then be prompted to schedule a date and time where those execution times will work, which may be challenging to schedule given the overall amount of time needed. Additionally, the 8 hours of downtime will not be contiguous, requiring two separate cycles of bringing the database offline and then online again, which is even more disruptive than if the 8 hours was schedule contiguously.

In an example embodiment, multiple service requests are bundled into a single bundle via the vertical bundling of the service requests. This involves modularizing the services into subcomponents, identifying common processes and identifying the modularized processes that can run in parallel, then ranking the modularized processes to create an execution plan that minimizes downtime and also schedules downtime in a single contiguous block. The execution plan represents an optimized executable sequence that can contain both related and non-related services in a single bundle for fulfillment. It also represents a blueprint of services requested by the user from a service catalog.

A ranking framework may also be provided that ranks and sequences all services on which an execution plan is created, in a service provider cockpit. This ranking framework may include metadata such as an execution category, which indicates whether the execution of the corresponding module is performed during downtime or uptime, as well as an indication of parallel ability of the corresponding module, which indicates whether the corresponding module can be run in parallel with other modules. The metadata may also include an indication of whether each corresponding module is dependent on another module, which can be used in determining an ordering of execution.

All services can be fulfilled in a single downtime by then running the execution plan formed from the ranking framework.

Therefore, rather than a user needing to find a first service, request and book an available time slot for the first service, find a second service, and request and book an available time slot for the second service, the user is instead able to find a first service and add it to a “service cart”, which operates similarly to a shopping cart in that it holds items for a later joint “checkout”. The user can then find a second service and add it to the service cart as well, and indeed may add additional services as well. The user can then book a single time slot to cover execution of all of the services in the service cart. This reduces the aforementioned technical problems of inefficiently taking devices or applications offline and cycling between offline and online modes.

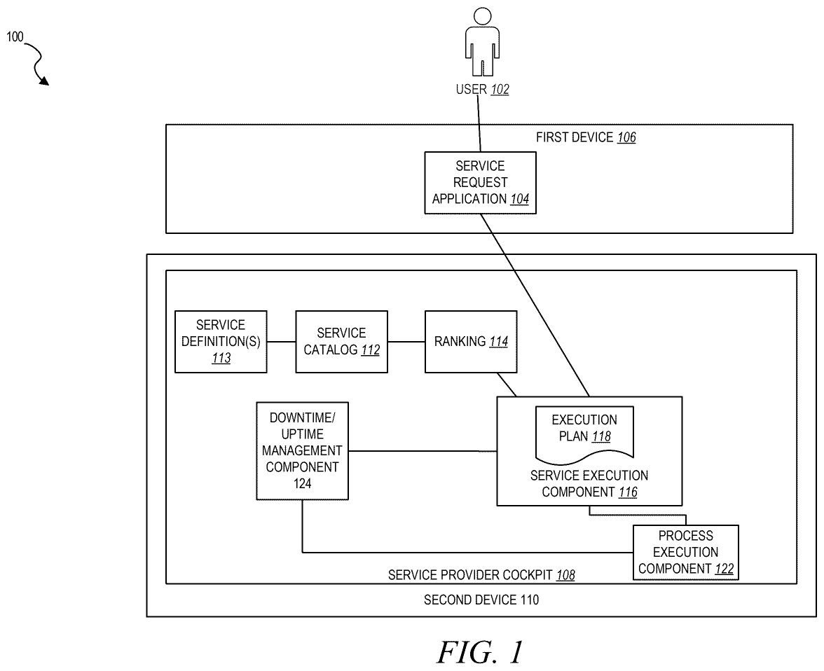

FIG. 1 is a block diagram illustrating a system 100 for executing a plurality of service requests, in accordance with an example embodiment. A user 102 may interact with a service request application 104 running on a first device 106. The first device 106 may be, for example a client device such as a mobile device or desktop computer, but also a server, which could be operated in the cloud or at customer side. The service request application 104 may itself interact with a service provider cockpit 108 running on a second device 110. The second device 110 may be, for example, a server device such as a hardware server operating at a service provider or at an entity that communicates with a service provider.

The service provider cockpit 108 may be utilized by users to maintain a service catalog 112. The service catalog 112 is a centralized repository or directory that contains information about all the services offered by an organization. These services could include various IT services, business processes, applications, and solutions that are available within the ecosystem.

The service catalog 112 provides detailed descriptions of each service, including its functionalities, features, dependencies, service level agreements (SLAs), and any associated costs. It serves as a comprehensive reference for both administrators and end-users to understand what services are available, how they can be accessed, and what they entail in terms of usage and support.

The descriptions in the service catalog 112 may include a service definition 113 for each service.

The service provider cockpit 108 may also be used by users to maintain a ranking 114 of modules of the services in the service catalog 112. Each service may comprise one or more modules that are executed in order to run the service. The ranking 114 represents a global ranking of all the modules across all the services. Essentially, the ranking 114 represents the order in which the modules would be executed if the user requested that all available services in the service catalog 112 be executed.

At runtime, the user 102 interacts with the service request application 104 in such a way as to generate a single request to execute a plurality of the available services from the service catalog 112. As mentioned before, this may be performed using a graphical user interface that allows the user to select on a first service and add that first service to a service cart, and then select on a second service and add that second service to a service cart, and so on, until the user has selected and added all services the user wishes to run. The user may then request that the services be scheduled. This generates a single service request, which may take the form of a ticket, to a service execution component 116 of the service provider cockpit 108.

The service execution component 116 forms an execution plan 118 based on the ranking 114 and the ticket. More particularly, the modules needed to execute the services selected in the ticket are placed into the execution plan 118 in the ordering suggested by the ranking 114. This can be thought of as taking the ranking 114 and removing any modules from the ranking that are not needed to execute the selected services in the ticket, although this is not literally what is happening since the execution plan is generated based on the ranking 114 but is not itself literally a filtered version of the ranking 114. The modules that are “removed” are the ones that are only needed to execute services that are not selected in the ticket as well as duplicate modules, specifically any module that is redundant with a module needed to execute one of the services selected in the ticket. For the latter, for example, if a particular module is part of both the first service and the second service contained in the ticket, then the second instance of that module can be removed as it is only necessary to execute that particular module once.

The execution plan 118 is then used to present available slots to schedule execution of the services selected in the ticket. Specifically, a downtime/uptime management component 124 may maintain a schedule of when various applications/devices are scheduled to be taken offline and/or placed online. The downtime management component 124 may then return to the service request application 104 a list of available slot(s), from which the user 102 can select. Once the user selects the time slot, this information may be sent to the service execution component 116, which triggers a process execution component 122 to execute the execution plan 118, in the specified order, at the specified time slot. This can include accessing the downtime/uptime management component 124, which manages the downtime and uptime of applications/devices. More particularly, the downtime/uptime management component 124 takes applications/devices offline or puts them back online when instructed by the process execution component 122.

In an example embodiment, the ranking 114 may be calculated using one or more machine learning models. Specifically, a modularization machine learning model may be trained to determine how best to modularize each service in the service catalog 112. Specifically, the modularization machine learning model may be trained by any algorithm from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbors, decision trees, and hidden Markov models.

In an example embodiment, a machine learning algorithm used to train the modularization machine learning model may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

Training data may include historical services and historical modules. For example, a human may have previously determined that a service should be broken into 4 modules. This information may be used to train the modularization machine learning model by using the machine learning algorithm to help identify features of services (based, for example, on their service definitions and execution code/script) that indicate how a similar service should be modularized. From this training data, the machine learning algorithm trains the modularization machine learning model to learn how to identify features that indicate that an input service should be divided into a particular number of modules in a particular way.

In some example embodiments, the training of the modularization machine learning model may take place as a dedicated training phase. In other example embodiments, the modularization machine learning model may be retrained dynamically at runtime based on, for example, developer or user feedback.

Another machine learning model may be used to perform the actual ranking of the modules themselves. A ranking machine learning model may be trained to determine how best to rank each module of each service in the service catalog 112. Specifically, the ranking machine learning model may be trained by any algorithm from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbors, decision trees, and hidden Markov models.

In an example embodiment, a machine learning algorithm used to train the ranking machine learning model may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function. The loss function may be a different loss function than that used to train the modularization machine learning model.

Training data may include historical rankings of historical modules, if available, as well as other indications of levels of priority of the historical modules. For example, a human may have previously determined that module A should be performed before module B. This information may be used to train the ranking machine learning model by using the machine learning algorithm to help identify features of modules that indicate how the priority of a module with respect to another module. From this training data, the machine learning algorithm trains the ranking machine learning model to learn how to identify features that indicate the prioritization of modules.

In some example embodiments, the training of the ranking machine learning model may take place as a dedicated training phase. In other example embodiments, the ranking machine learning model may be retrained dynamically at runtime based on, for example, developer or user feedback.

The modularization machine learning model can be used along with the ranking machine learning model, or either of them could be used alone, although the use of any of the machine learning models is also optional as it is also possible for the ranking 114 to be pre-provided.

In another example embodiment, an additional machine learning model is used to streamline the service request application 104, and specifically to allow the user to utilize natural language (either written or oral) to select the services to be added to the service cart.

This machine learning model may include, for example, a Bidirectional Encoder Representations from Transformers (BERT) model, to encode text portions into embeddings. BERT is a type of natural language processing (NLP) model based on the transformer architecture. BERT uses one or more transformer layer(s) within a neural network to encode the input sentence to an embedding. Each transformer layer is defined as follows:

$$TFLayer ( {h}^{n - 1} ) = FC ( MultiAttn ( {h}^{n - 1} ) ) ;$$

$$FC ( x ) = relu ( {xW}_{1} + {b}_{1} ) {W}_{2} + {b}_{2} ;$$

$$MultiAttn ( {h}^{n - 1} ) = concat ( {head}_{1} ( {h}^{n - 1} ) , … , {head}_{k} ( {h}^{n - 1} ) ) {W}^{O} ,$$

$${head}_{i} ( {h}^{n - 1} ) = soft max ( \frac{( {h}^{n - 1} {W}_{q}^{i} ) ( {h}^{n - 1} {W}_{k}^{i} )}{\sqrt{{d}_{k}}} ) ( {h}^{n - 1} {W}_{v}^{i} ) .$$

where hⁿ⁻¹ is the output of the previous transformer layer.

In another example embodiment, the natural language machine learning model is a Word2Vec model. Word2Vec uses an embedder, which is a shallow, two-layer neural network trained to reconstruct linguistic contexts of words. Word2Vec takes as input a large corpus of text and produces a vector space, typically of several hundred dimensions, with each unique word in the corpus being assigned a corresponding vector in the space. Word vectors are positioned in the vector space such that words that share common contexts in the corpus are in close proximity to one another in the space.

In another example embodiment, a sentence similarity transformer model may be used in the natural language machine learning model. A sentence similarity transformer model is a type of natural language processing (NLP) model designed to measure the similarity between two sentences or pieces of text. It leverages transformer architecture, which has been highly successful in various NLP tasks. Transformer models are known for their ability to capture contextual information effectively and have been the foundation for many state-of-the-art NLP applications.

The goal of a sentence similarity transformer model is to determine how similar or related two sentences are, often by providing a similarity score or metric.

In another example embodiment, a large language model may be used as part of the machine learning model. Here, a large language model (LLM) refers to an artificial intelligence (AI) system that has been trained on an extensive dataset to understand and generate human language. These models are designed to process and comprehend natural language in a way that allows them to answer questions, engage in conversations, generate text, and perform various language-related tasks.

It should be noted that the operations performed by each service may include pre-processing, execution, and post-processing operations. Thus, in example embodiments, the modules may also be divided into pre-processing modules, execution modules, and post-processing modules, corresponding to these operations. The ranking need only rank execution modules, and thus can exclude modules that pertain to pre-processing or post-processing operations, since these modules typically do not involve any downtime to an application or device.

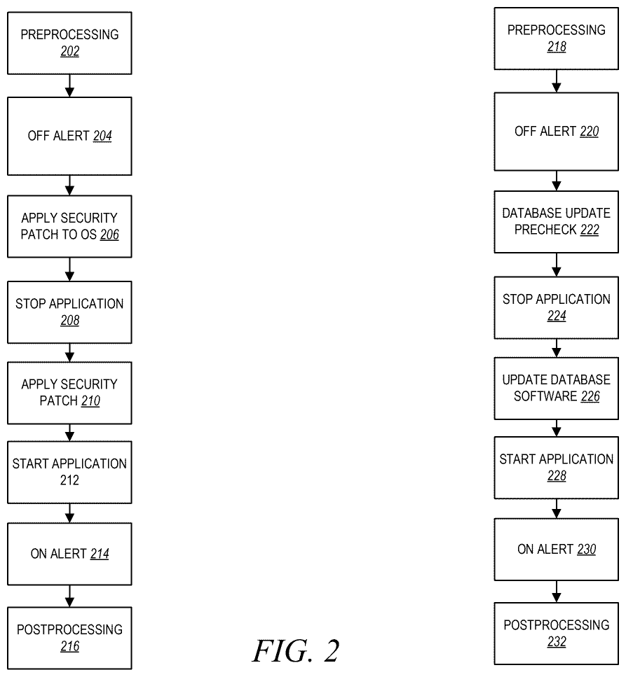

FIG. 2 is a diagram illustrating an example of modules of two services offered by a service provider, in accordance with an example embodiment. This is an extension of the earlier example of a first service to apply a security patch and a second service to update a database. Here, the first service contains eight modules, specifically a preprocessing module 202, a module 204, which sends an off alert, a module 206, which applies a security patch to the operating system, a module 208, which stops an application, a module 210, which applies the security patch, a module 212, which starts the application, a module 214, which sends an on alert, and a post-processing module 216. The second service also contains eight modules, specifically a preprocessing module 218, a module 220, which sends an off alert, a module 222, which performs a database update precheck, a module 224, which stops an application, a module 226, which updates the database software, a module 228, which starts the application, a module 230, which sends an on alert, and a post-processing module 232.

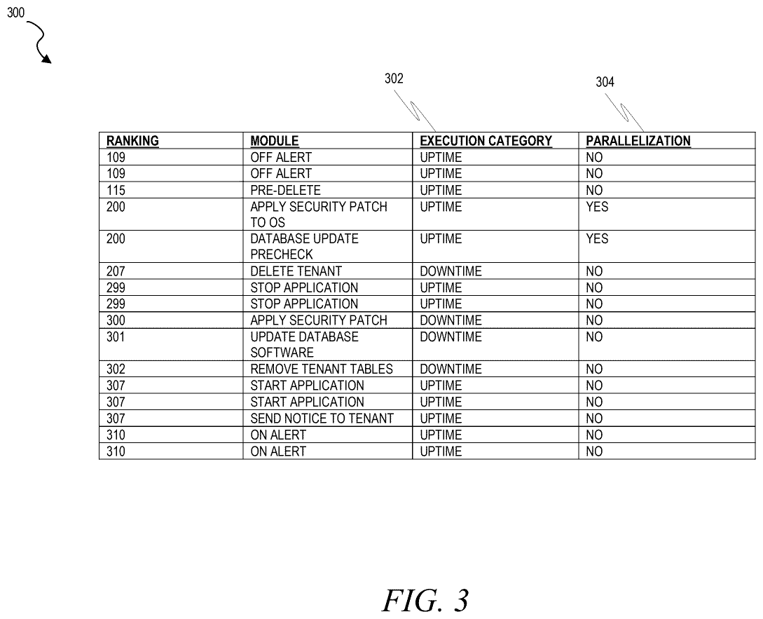

FIG. 3 is a diagram illustrating a ranking 300 of modules of a service provider, in accordance with an example embodiment. Here, the modules of the first and second services are ranked, but so are modules of other services of the service provider. The ranking 300 only comprises modules contained in the execution portion of each service, and thus the preprocessing modules 202, 216 and the post-processing modules 214 and 228 from FIG. 2 are not present in the ranking 300. As can be seen, the ranking 300 comprises execution category metadata 302, which indicates whether each corresponding module is performed during uptime or downtime. The ranking 300 also comprises parallelization metadata 304, which indicates whether each corresponding model is able to be parallelized.

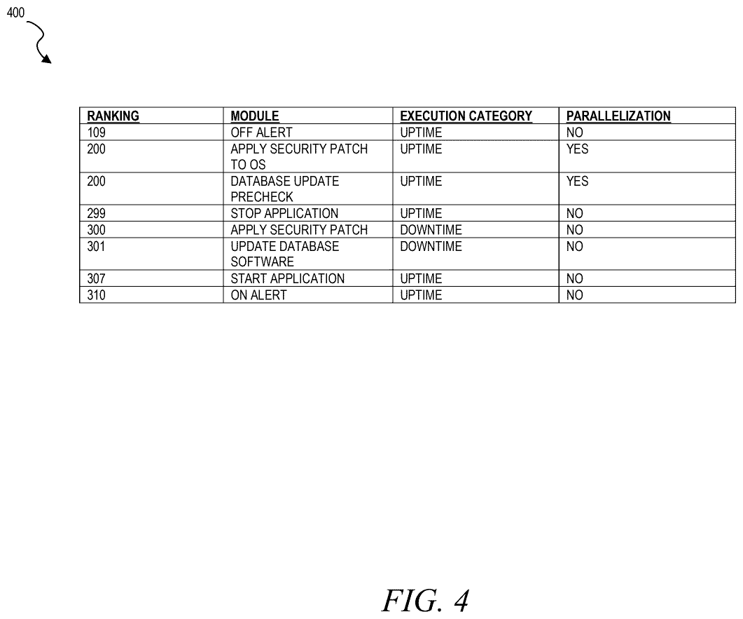

FIG. 4 is a diagram illustrating an execution plan 400 formed via the ranking 300 and a service request that requests execution of the first and second service, in accordance with an example embodiment. As can be seen, this is similar to the ranking 300, except that it contains only the modules that are contained in the first and second services, as this is what was requested in the service request. Also, modules that are redundant between the first and second services are removed. For example, module 204 and module 220 are redundant since both involve the sending of an off alert. As such, only a single module representing sending an off alert is present in the execution plan 400. This acts to save execution time when the execution plan 400 is executed.

Additionally, since the modules 206 and 222 were listed in the ranking 300 as being parallelized, they are organized to be parallel processed in the execution plan 400. Furthermore, since the modules 210 and 226 were listed in the ranking 300 as being in the downtime execution category, these modules are organized to be performed sequentially to group downtime modules together.

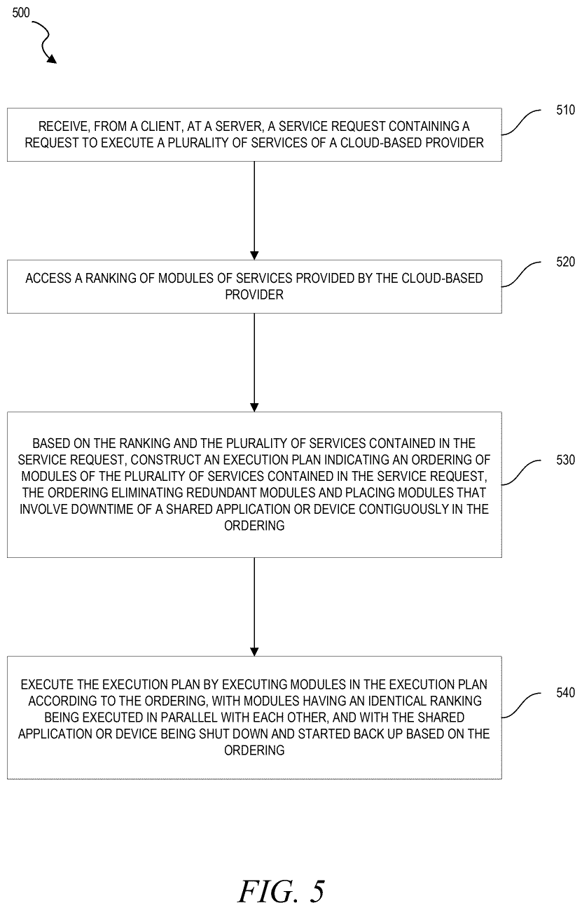

FIG. 5 is a flow diagram illustrating a method 500 for executing a service request containing multiple services, in accordance with an example embodiment.

At step 510, a service request containing a request to execute a plurality of services of a cloud-based provider is received from a client at a server.

At step 520, a ranking of modules of services provided by the cloud-based provider is accessed.

At step 530, based on the ranking and the plurality of services contained in the service request, an execution plan indicating an ordering of modules of the plurality of services contained in the service request is constructed. The ordering eliminates redundant modules and places modules that involve downtime of a shared application or device contiguously in the ordering.

At step 540, the execution plan is performed by executing modules in the execution plan according to the ordering, with modules having an identical ranking being executed in parallel with each other, and with the shared application or device being shut down and started back up based on the ordering.

Example 1 is a system comprising: at least one hardware processor; and a computer-readable medium storing instructions that, when executed by the at least one hardware processor, cause the at least one hardware processor to perform operations comprising: receiving, from a client, at a server, a service request containing a request to execute a plurality of services of a cloud-based provider; accessing a ranking of modules of services provided by the cloud-based provider; based on the ranking and the plurality of services contained in the service request, constructing an execution plan indicating an ordering of modules of the plurality of services contained in the service request, the ordering eliminating redundant modules and placing modules that involve downtime of a shared application or device contiguously in the ordering; and executing the execution plan by executing modules in the execution plan according to the ordering, with modules having an identical ranking being executed in parallel with each other, and with the shared application or device being shut down and started back up based on the ordering.

In Example 2, the subject matter of Example 1 comprises, wherein the operations further comprise: using the ranking and the plurality of services to identify a length of downtime needed to execute the service request; and identifying one or more available time slots based on the length of downtime needed; and sending the one or more available time slots to the client.

In Example 3, the subject matter of Example 2 comprises, wherein the executing is performed in response to a determination that a current time matches a beginning time of a selected time slot, as indicated by the client, of the one or more available time slots.

In Example 4, the subject matter of Examples 1-3 comprises, wherein the ranking is generated using a modularization machine learning model trained by a machine learning algorithm to identify, for each service provided by the service provider, a set of one or more modules used to execute a corresponding service.

In Example 5, the subject matter of Examples 1˜4 comprises, wherein the ranking is generated using a ranking machine learning model trained by a machine learning algorithm to rank each module of each service provided by the service provider based on priority.

In Example 6, the subject matter of Examples 1-5 comprises, wherein the service request is generated by the client via a natural language machine learning model that takes a natural language request by a user, the natural language request not explicitly identifying the plurality of services, and identifies the plurality of services.

In Example 7, the subject matter of Examples 4-6 comprises, wherein the modularization machine learning model is a neural network.

In Example 8, the subject matter of Examples 1-7 comprises, wherein the ranking is generated using modularization machine learning model trained by a first machine learning algorithm to identify, for each service provided by the service provider, a set of one or more modules used to execute a corresponding service, the set of one or more modules passed to a ranking machine learning model trained by a second machine learning algorithm to rank each module of each service provided by the service provider based on priority.

In Example 9, the subject matter of Examples 1-8 comprises, wherein the ranking excludes modules executed during pre-processing or post-processing of a service.

Example 10 is a method comprising: receiving, from a client, at a server, a service request containing a request to execute a plurality of services of a cloud-based provider; accessing a ranking of modules of services provided by the cloud-based provider; based on the ranking and the plurality of services contained in the service request, constructing an execution plan indicating an ordering of modules of the plurality of services contained in the service request, the ordering eliminating redundant modules and placing modules that involve downtime of a shared application or device contiguously in the ordering; and executing the execution plan by executing modules in the execution plan according to the ordering, with modules having an identical ranking being executed in parallel with each other, and with the shared application or device being shut down and started back up based on the ordering.

In Example 11, the subject matter of Example 10 comprises, using the ranking and the plurality of services to identify a length of downtime needed to execute the service request; and identifying one or more available time slots based on the length of downtime needed; and sending the one or more available time slots to the client.

In Example 12, the subject matter of Example 11 comprises, wherein the executing is performed in response to a determination that a current time matches a beginning time of a selected time slot, as indicated by the client, of the one or more available time slots.

In Example 13, the subject matter of Examples 10-12 comprises, wherein the ranking is generated using a modularization machine learning model trained by a machine learning algorithm to identify, for each service provided by the service provider, a set of one or more modules used to execute a corresponding service.

In Example 14, the subject matter of Examples 10-13 comprises, wherein the ranking is generated using a ranking machine learning model trained by a machine learning algorithm to rank each module of each service provided by the service provider based on priority.

In Example 15, the subject matter of Examples 10-14 comprises, wherein the service request is generated by the client via a natural language machine learning model that takes a natural language request by a user, the natural language request not explicitly identifying the plurality of services, and identifies the plurality of services.

In Example 16, the subject matter of Examples 13-15 comprises, wherein the modularization machine learning model is a neural network.

Example 17 is a non-transitory machine-readable medium storing instructions which, when executed by one or more processors, cause the one or more processors to perform operations comprising: receiving, from a client, at a server, a service request containing a request to execute a plurality of services of a cloud-based provider; accessing a ranking of modules of services provided by the cloud-based provider; based on the ranking and the plurality of services contained in the service request, constructing an execution plan indicating an ordering of modules of the plurality of services contained in the service request, the ordering eliminating redundant modules and placing modules that involve downtime of a shared application or device contiguously in the ordering; and executing the execution plan by executing modules in the execution plan according to the ordering, with modules having an identical ranking being executed in parallel with each other, and with the shared application or device being shut down and started back up based on the ordering.

In Example 18, the subject matter of Example 17 comprises, wherein the operations further comprise: using the ranking and the plurality of services to identify a length of downtime needed to execute the service request; and identifying one or more available time slots based on the length of downtime needed; and sending the one or more available time slots to the client.

In Example 19, the subject matter of Example 18 comprises, wherein the executing is performed in response to a determination that a current time matches a beginning time of a selected time slot, as indicated by the client, of the one or more available time slots.

In Example 20, the subject matter of Examples 17-19 comprises, wherein the ranking is generated using a modularization machine learning model trained by a machine learning algorithm to identify, for each service provided by the service provider, a set of one or more modules used to execute a corresponding service.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

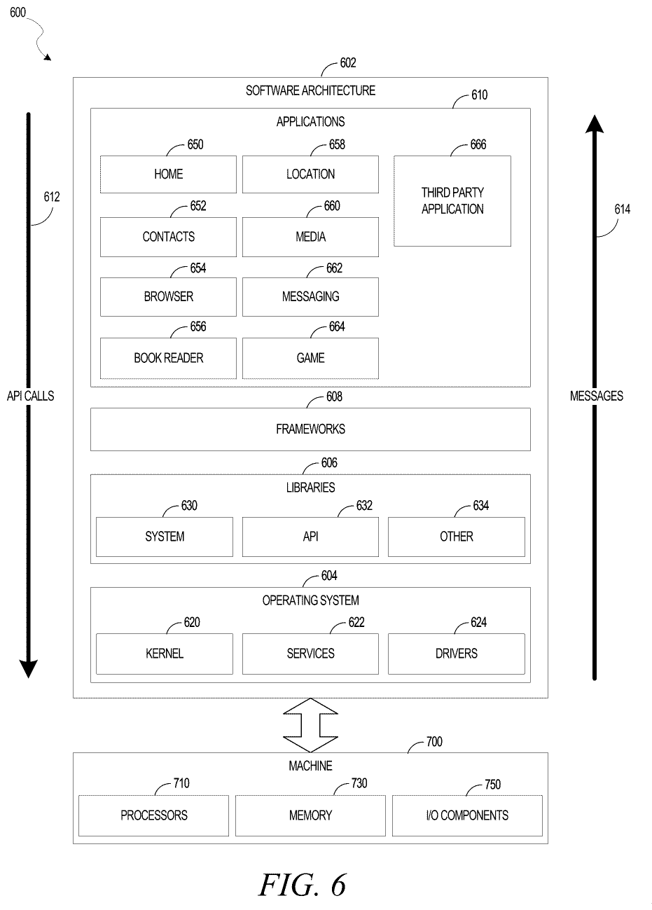

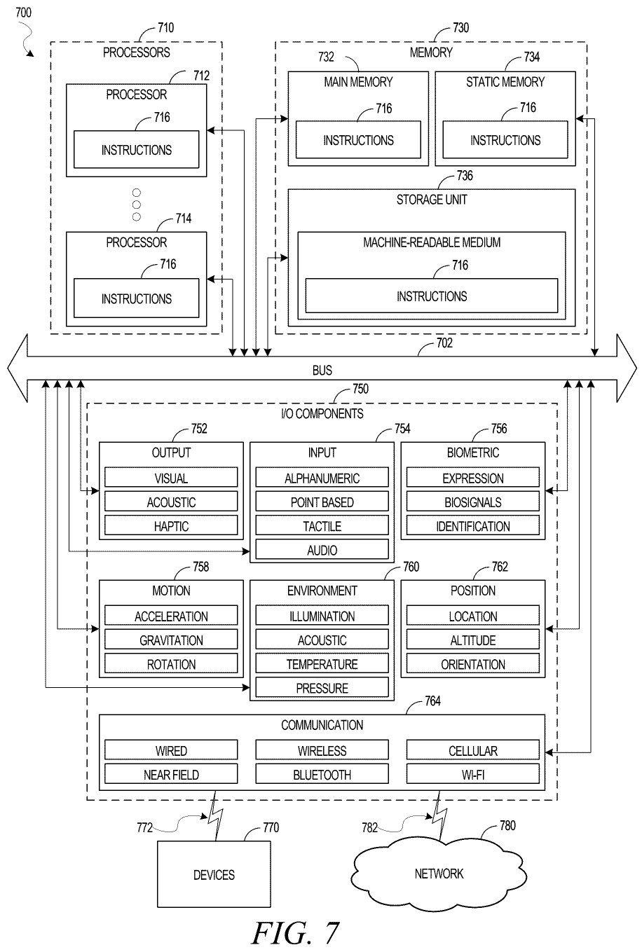

FIG. 6 is a block diagram 600 illustrating a software architecture 602, which can be installed on any one or more of the devices described above. FIG. 6 is merely a non-limiting example of a software architecture, and it will be appreciated that many other architectures can be implemented to facilitate the functionality described herein. In various embodiments, the software architecture 602 is implemented by hardware such as a machine 700 of FIG. 7 that comprises processors 710, memory 730, and input/output (I/O) components 750. In this example architecture, the software architecture 602 can be conceptualized as a stack of layers where each layer may provide a particular functionality. For example, the software architecture 602 comprises layers such as an operating system 604, libraries 606, frameworks 608, and applications 610. Operationally, the applications 610 invoke API calls 612 through the software stack and receive messages 614 in response to the API calls 612, consistent with some embodiments.

In various implementations, the operating system 604 manages hardware resources and provides common services. The operating system 604 comprises, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionalities. The services 622 can provide other common services for the other software layers. The drivers 624 are responsible for controlling or interfacing with the underlying hardware, according to some embodiments. For instance, the drivers 624 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematic functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics [PNG]), graphics libraries (e.g., an OpenGL framework used to render in 2D and 6D in a graphic context on a display), database libraries (e.g., SQLite to provide various relational database functions), web libraries (e.g., WebKit to provide web browsing functionality), and the like. The libraries 606 can also include a wide variety of other libraries 634 to provide many other APIs to the applications 610.

The frameworks 608 provide a high-level common infrastructure that can be utilized by the applications 610, according to some embodiments. For example, the frameworks 608 provide various graphical user interface (GUI) functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a book reader application 656, a location application 658, a media application 660, a messaging application 662, a game application 664, and a broad assortment of other applications, such as a third-party application 666. According to some embodiments, the applications 610 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third-party application 666 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 612 provided by the operating system 604 to facilitate functionality described herein.

FIG. 7 illustrates a diagrammatic representation of a machine 700 in the form of a computer system within which a set of instructions may be executed for causing the machine 700 to perform any one or more of the methodologies discussed herein, according to an example embodiment. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example, the instructions 716 may cause the machine 700 to execute the method of FIG. 4. Additionally, or alternatively, the instructions 716 may implement FIGS. 1-5 and so forth. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 712 and a processor 714 that may execute the instructions 716. The term “processor” is intended to include multi-core processors that may comprise two or more independent processors (sometimes referred to as “cores”) that may execute instructions 716 contemporaneously. Although FIG. 7 shows multiple processors 710, the machine 700 may include a single processor 712 with a single core, a single processor 712 with multiple cores (e.g., a multi-core processor 712), multiple processors 712, 714 with a single core, multiple processors 712, 714 with multiple cores, or any combination thereof.

The memory 730 may include a main memory 732, a static memory 734, and a storage unit 736, each accessible to the processors 710 such as via the bus 702. The main memory 732, the static memory 734, and the storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor's cache memory), or any suitable combination thereof, during execution thereof by the machine 700.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In various example embodiments, the I/O components 750 may include output components 752 and input components 754. The output components 752 may include visual components (e.g., a display such as a plasma display panel (PDP), a light-emitting diode (LED) display, a liquid crystal display (LCD), a projector, or a cathode ray tube [CRT]), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., coupled via a USB).

Moreover, the communication components 764 may detect identifiers or include components operable to detect identifiers. For example, the communication components 764 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

The various memories (e.g., 730, 732, 734, and/or memory of the processor(s) 710) and/or the storage unit 736 may store one or more sets of instructions 716 and data structures (e.g., software) embodying or utilized by any one or more of the methodologies or functions described herein. These instructions (e.g., the instructions 716), when executed by the processor(s) 710, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 780 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., Hypertext Transfer Protocol [HTTP]). Similarly, the instructions 716 may be transmitted or received using a transmission medium via the coupling 772 (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 716 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
receiving, from a client, at a server, a service request containing a request to execute a plurality of services of a cloud-based provider;
accessing a ranking of modules of services provided by the cloud-based provider;
based on the ranking and the plurality of services contained in the service request, constructing an execution plan indicating an ordering of modules of the plurality of services contained in the service request, the ordering eliminating redundant modules and placing modules that involve downtime of a shared application or device contiguously in the ordering; and
executing the execution plan by executing modules in the execution plan according to the ordering, with modules having an identical ranking being executed in parallel with each other, and with the shared application or device being shut down and started back up based on the ordering.

2. The system of claim 1, wherein the operations further comprise:
using the ranking and the plurality of services to identify a length of downtime needed to execute the service request; and
identifying one or more available time slots based on the length of downtime needed; and
sending the one or more available time slots to the client.

3. The system of claim 2, wherein the executing is performed in response to a determination that a current time matches a beginning time of a selected time slot, as indicated by the client, of the one or more available time slots.

4. The system of claim 1, wherein the ranking is generated using a modularization machine learning model trained by a machine learning algorithm to identify, for each service provided by the cloud-based provider, a set of one or more modules used to execute a corresponding service.

5. The system of claim 1, wherein the ranking is generated using a ranking machine learning model trained by a machine learning algorithm to rank each module of each service provided by the cloud-based provider based on priority.

6. The system of claim 1, wherein the service request is generated by the client via a natural language machine learning model that takes a natural language request by a user, the natural language request not explicitly identifying the plurality of services, and identifies the plurality of services.

7. The system of claim 4, wherein the modularization machine learning model is a neural network.

8. The system of claim 1, wherein the ranking is generated using modularization machine learning model trained by a first machine learning algorithm to identify, for each service provided by the cloud-based provider, a set of one or more modules used to execute a corresponding service, the set of one or more modules passed to a ranking machine learning model trained by a second machine learning algorithm to rank each module of each service provided by the cloud-based provider based on priority.

9. The system of claim 1, wherein the ranking excludes modules executed during pre-processing or post-processing of a service.

10. A method comprising:
receiving, from a client, at a server, a service request containing a request to execute a plurality of services of a cloud-based provider;
accessing a ranking of modules of services provided by the cloud-based provider;
based on the ranking and the plurality of services contained in the service request, constructing an execution plan indicating an ordering of modules of the plurality of services contained in the service request, the ordering eliminating redundant modules and placing modules that involve downtime of a shared application or device contiguously in the ordering; and
executing the execution plan by executing modules in the execution plan according to the ordering, with modules having an identical ranking being executed in parallel with each other, and with the shared application or device being shut down and started back up based on the ordering.

11. The method of claim 10, further comprising:
using the ranking and the plurality of services to identify a length of downtime needed to execute the service request; and
identifying one or more available time slots based on the length of downtime needed; and
sending the one or more available time slots to the client.

12. The method of claim 11, wherein the executing is performed in response to a determination that a current time matches a beginning time of a selected time slot, as indicated by the client, of the one or more available time slots.

13. The method of claim 10, wherein the ranking is generated using a modularization machine learning model trained by a machine learning algorithm to identify, for each service provided by the cloud-based provider, a set of one or more modules used to execute a corresponding service.

14. The method of claim 10, wherein the ranking is generated using a ranking machine learning model trained by a machine learning algorithm to rank each module of each service provided by the cloud-based provider based on priority.

15. The method of claim 10, wherein the service request is generated by the client via a natural language machine learning model that takes a natural language request by a user, the natural language request not explicitly identifying the plurality of services, and identifies the plurality of services.

16. The method of claim 13, wherein the modularization machine learning model is a neural network.

17. A non-transitory machine-readable medium storing instructions which, when executed by one or more processors, cause the one or more processors to perform operations comprising:
receiving, from a client, at a server, a service request containing a request to execute a plurality of services of a cloud-based provider;
accessing a ranking of modules of services provided by the cloud-based provider;
based on the ranking and the plurality of services contained in the service request, constructing an execution plan indicating an ordering of modules of the plurality of services contained in the service request, the ordering eliminating redundant modules and placing modules that involve downtime of a shared application or device contiguously in the ordering; and
executing the execution plan by executing modules in the execution plan according to the ordering, with modules having an identical ranking being executed in parallel with each other, and with the shared application or device being shut down and started back up based on the ordering.

18. The non-transitory machine-readable medium of claim 17, wherein the operations further comprise:
using the ranking and the plurality of services to identify a length of downtime needed to execute the service request; and
identifying one or more available time slots based on the length of downtime needed; and
sending the one or more available time slots to the client.

19. The non-transitory machine-readable medium of claim 18, wherein the executing is performed in response to a determination that a current time matches a beginning time of a selected time slot, as indicated by the client, of the one or more available time slots.

20. The non-transitory machine-readable medium of claim 17, wherein the ranking is generated using a modularization machine learning model trained by a machine learning algorithm to identify, for each service provided by the cloud-based provider, a set of one or more modules used to execute a corresponding service.
